(19) United States
(12) Patent Application Publication
(10) Pub. No.: US 2007/0112703 A1
(43) Pub. Date: May 17, 2007

(54) Adaptive teaching material generation methods and systems

(75) Inventors: Jiun Gu, Taipei City (TW); Hung-Sheng Chiu, Taipei County (TW); Sung-Chieh Chen, Taipei City (TW)

Correspondence Address: BIRCH STEWART KOLASCH & BIRCH, PO BOX 747, FALLS CHURCH, VA, 22040-0747, US

(73) Assignee: Institute for Information Industry

(21) Appl. No.: 11/333,323

(22) Filed: Jan. 18, 2006

(30) Foreign Application Priority Data
Nov. 15, 2005 (TW) 94140055

(51) Int. Cl. G06F 15/18

(52) U.S. Cl. 706/20

(57) ABSTRACT

An adaptive teaching material generation system comprises a database, an authoring tool, and a course structure generator. The database provides a plurality of graphical templates for e-learning sequencing. The authoring tool provides an interface allowing one of the graphical templates to be dragged for forming a structure diagram for sequencing e-learning nodes comprised therein. The course structure generator automatically generates a course structure corresponding to the structure diagram, comprising sequencing settings of each node.

### BACKGROUND OF THE INVENTION

1. Field of the Invention

The present invention relates to computer techniques, and more particularly to adaptive teaching material generation methods and systems.

2. Description of the Related Art

The shareable content object reference model (SCORM) 2004 proposed by advanced distributed learning (ADL) adopts the IMS simple sequencing specification, which is absent in the previous version of SCORM 1.2.

The IMS simple sequencing specification developed by IMS Global Learning Consortium defines a method for representing the intended behavior of an authored learning experience utilizing extensible markup language (XML). SCORM 2004 is increasingly supported by various authoring tools. Simple sequence editing with current authoring tools, such as Reload 2004, however, is still complex, time-consuming, and difficult work.

### BRIEF SUMMARY OF THE INVENTION

An exemplary embodiment of an adaptive teaching material generation system comprises a database, an authoring tool, and a course structure generator. The database provides a plurality of graphical templates for e-learning sequencing. The authoring tool interface provides graphical templates draggable for forming a structure diagram for sequencing e-learning nodes comprised therein. The course structure generator automatically generates a course structure corresponding to the structure diagram, comprising sequencing settings of each node.

An exemplary embodiment of an adaptive teaching material generation method is provided. A plurality of graphical templates for e-learning sequencing is provided draggable for forming a structure diagram for sequencing e-learning nodes. A course structure corresponding to the structure diagram is automatically generated, comprising sequencing settings of each node.

The method can be implemented with a computer application recorded in a storage medium such as a memory or a memory device. The computer application, when loaded into a computer, directs the computer to execute the described adaptive teaching material method.

A detailed description is given in the following embodiments with reference to the accompanying drawings.

### BRIEF DESCRIPTION OF THE DRAWINGS

The invention can be more fully understood by reading the subsequent detailed description and examples with references made to the accompanying drawings, wherein:

FIG. 1 is a block diagram of an exemplary embodiment of an adaptive teaching material generation system;

FIG. 2 is a schematic view showing a plurality of graphical templates for e-learning sequencing;

FIG. 3 is a schematic view showing a plurality of template objects;

FIG. 4 is a schematic view showing interfaces for editing course structures and content;

FIG. 5 is a schematic diagram of an example of a course structure;

FIG. 6 is an example of structure codes of the course structure;

FIG. 7 is a schematic diagram of exemplary course content generated by a course generator;

FIG. 8 is an XML file of a course;

FIG. 9 is a flowchart of an exemplary embodiment of an adaptive teaching material generation method; and

FIG. 10 is a schematic diagram of a storage medium.

### DETAILED DESCRIPTION OF THE INVENTION

The following description is of the best-contemplated mode of carrying out the invention. This description is made for the purpose of illustrating the general principles of the invention and should not be taken in a limiting sense. The scope of the invention is best determined by reference to the appended claims.

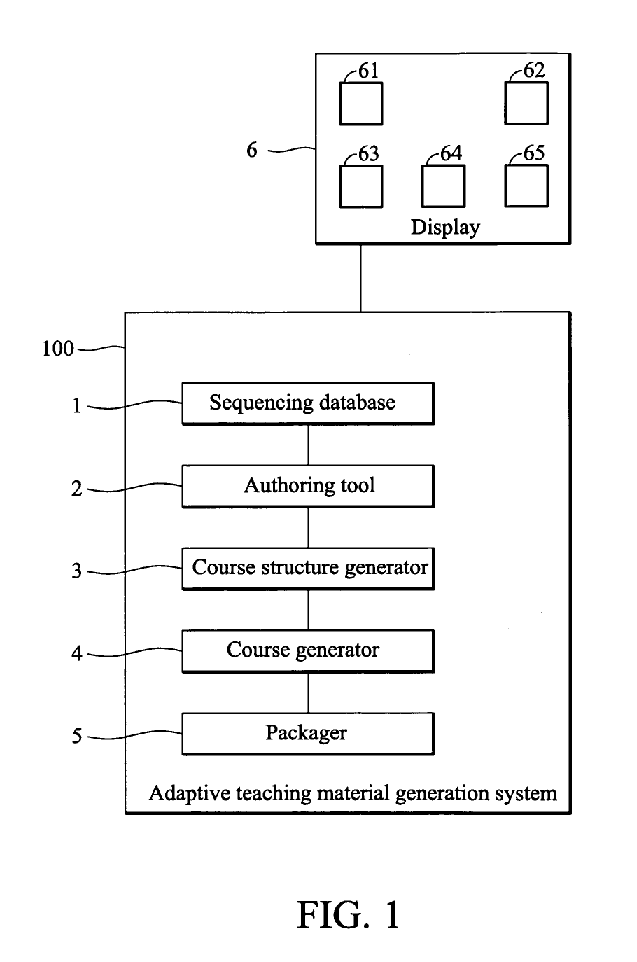

In FIG. 1, adaptive teaching material generation system 100 comprises a sequencing database 1, authoring tool 2, course structure generator 3, course generator 4, and packager 5. System 100 is coupled to display 6.

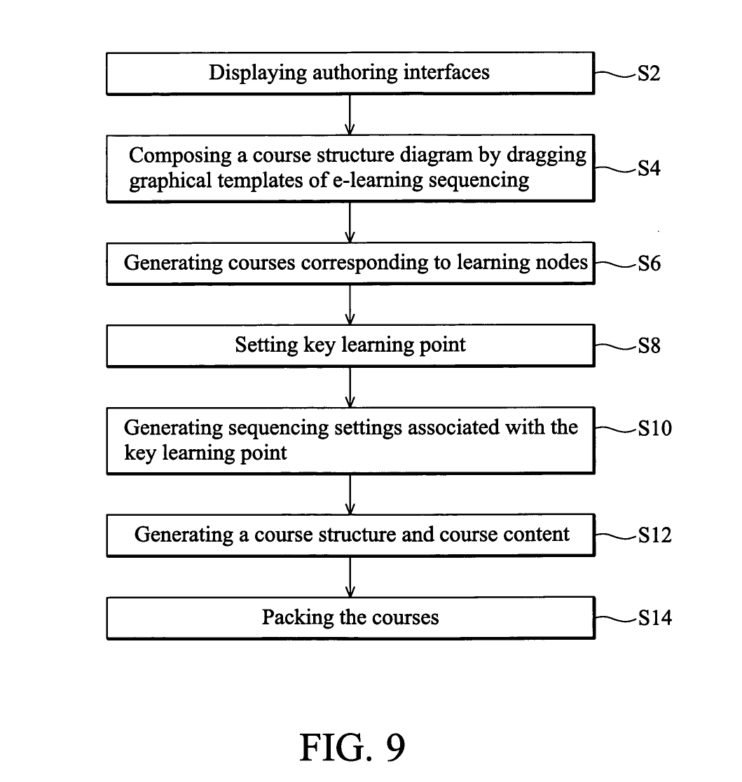

With reference to an adaptive teaching material generation method shown in FIG. 9, authoring tool 2 and course generator 4 display modules for course structure and content editing (step S2).

Sequencing database 1 provides a plurality of graphical templates for sequencing e-learning experiences. Each template comprises three parts: <title>, <item>, and <imsss:sequencing>, wherein <imsss:sequencing> comprises sequencing settings, such as settings of “controlMode”, “sequencingRules”, “limitCondition”, “auxiliaryResources”, “rollupRules”, “objectives”, “randomizationControls”, “deliveryControls”, “constrainedChoiceConsiderations”, and “rollupConsiderations”.

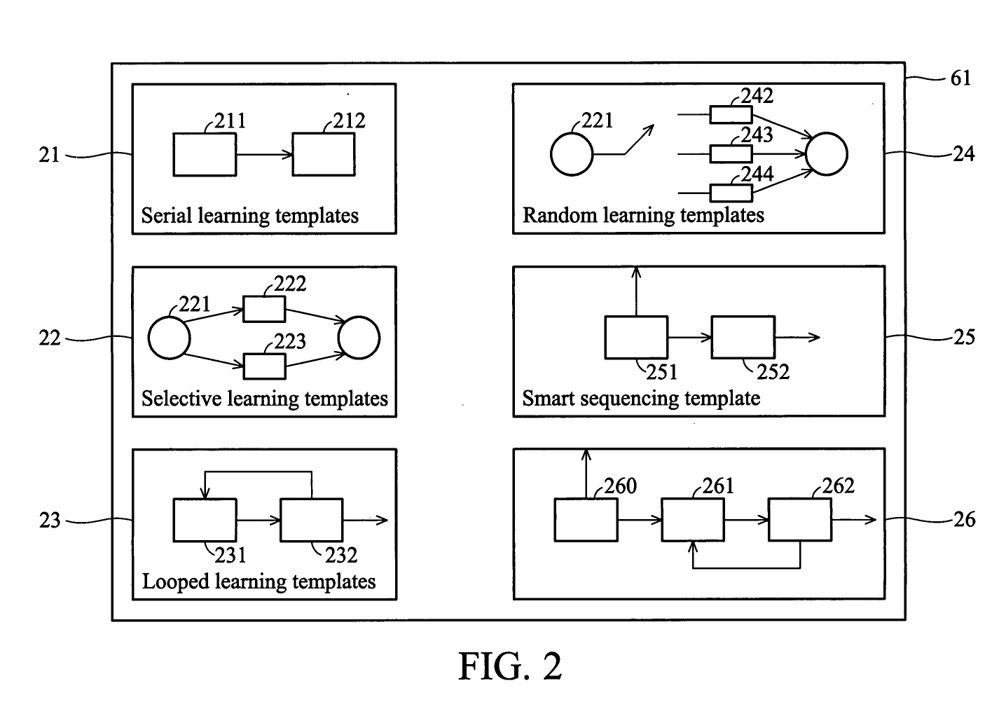

The graphical templates for e-learning sequencing comprise five types of templates: serial learning; selective learning; looped learning; random learning; and smart sequencing. As shown in FIG. 2, authoring tool 2 may display serial learning templates 21, selective learning templates 22, looped learning templates 23, random learning templates 24, and smart sequencing template 25 on area 61 of display 6, respectively corresponding to these five types (step S2). Serial learning template 21 comprises learning nodes 211 and 212. When learning node 211 has been opened by a learner, learning node 212 can be successively opened. Exemplary sequencing settings of serial learning template 21 is provides as follows:

<imsss:controlMode flow=“true”>

Selective learning template 22 comprises learning nodes 221, 222 and 223. When learning node 221 has been opened by a learner, learning node 222 or 223 can be selected to open. Exemplary sequencing settings of selective learning template 22 is provided as follows:

<imsss:controlMode choice=“true”>

Looped learning templates 23 comprise learning nodes 231 and 232. When learning node 231 has been opened by a learner, learning node 232 can be successively opened. When learning node 232 has been opened by the learner, learning node 231 can be repeatedly opened based on the learning status of the learner, which is stored in a corresponding data model. Exemplary sequencing settings of looped learning template 23 is provides as follows:

```
<imsss:postConditionRule>
  <imsss:ruleConditions>
    <imsss:ruleCondition condition=“satisfied” />
  </imsss:ruleConditions>
  <imsss:ruleAction action=“retryAll” />
</ imsss:postConditionRule >
```

Random learning templates 24 comprises learning nodes 241˜244. When learning node 241 has been opened by a learner, learning node 242, 243, or 244 can be opened randomly. Exemplary sequencing settings of random learning template 24 is provides as follows:

<imsss:randomizationControls
randomizationTiming = “onEachNewAttempt”
reorderChildren = “true” selectCount=“1”
selectionTiming=“onEachNewAttempt” />

Smart sequencing template 25 comprises learning nodes 251 and 252. When a test question in learning node 251 has been answered by a learner, whether learning node 252 next to learning node 251 is to be opened is determined based on the answer to the test question. Exemplary sequencing settings of learning node 251 is provides as follows:

```
  <imsss:objectives>
    <imsss:primaryObjective objectiveID=“PRIMARYOBJ”
      satisfiedByMeasure=“true”>
  <imsss:minNormalizedMeasure>0.6</imsss:minNormalizedMeasure>
    <imsss:mapInfo targetObjectiveID=“obj_module_1“
    writeSatisfiedStatus=“true” writeNormalizedMeasure=“true” />
    </imsss:primaryObjective>
  </imsss:objectives>
  <imsss:controlMode flow = “true”>
  Exemplary sequencing settings of learning node 252 is provides
  as follows:
  <imsss:objectives>
    <imsss:primaryObjective objectiveID=“PRIMARYOBJ”
satisfiedByMeasure=“true”>
  <imsss:minNormalizedMeasure>0.6</imsss:minNormalizedMeasure>
    <imsss:mapInfo targetObjectiveID=“obj_module_1“>
    </imsss:primaryObjective>
  </imsss:objectives>
  <imsss:preConditionRule>
    <imsss:ruleConditions>
    <imsss:ruleCondition condition=“satisfied” />
    </imsss:ruleConditions>
    <imsss:ruleAction action=“skip” />
  </ imsss:preConditionRule >
```

Smart sequencing template 26 comprises learning nodes 260˜262. When a test question in learning node 260 has been answered by a learner, whether learning node 261 next to learning node 260 is to be opened is determined based on the answer to the test question. Learning node 262 is opened after learning node 261. After the learner is tested in learning node 262, whether learning node 261 is to be opened again is determined based on the answer in learning node 262. Learning nodes 251 and 260 is referred to as pretests. Learning node 262 is referred to as a posttest.

Authoring tool 2 provides interfaces allowing the graphical templates to be dragged to form a course structure diagram for sequencing e-learning nodes, and further modify the course structure diagram, such as learning node insertion and sequencing settings adjustment (step S4).

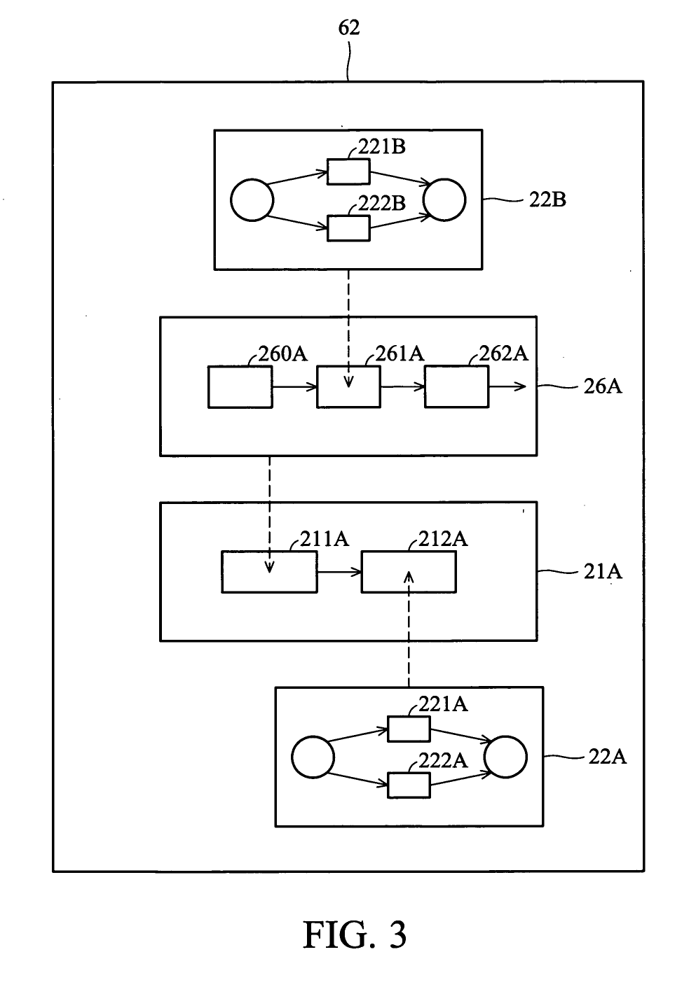

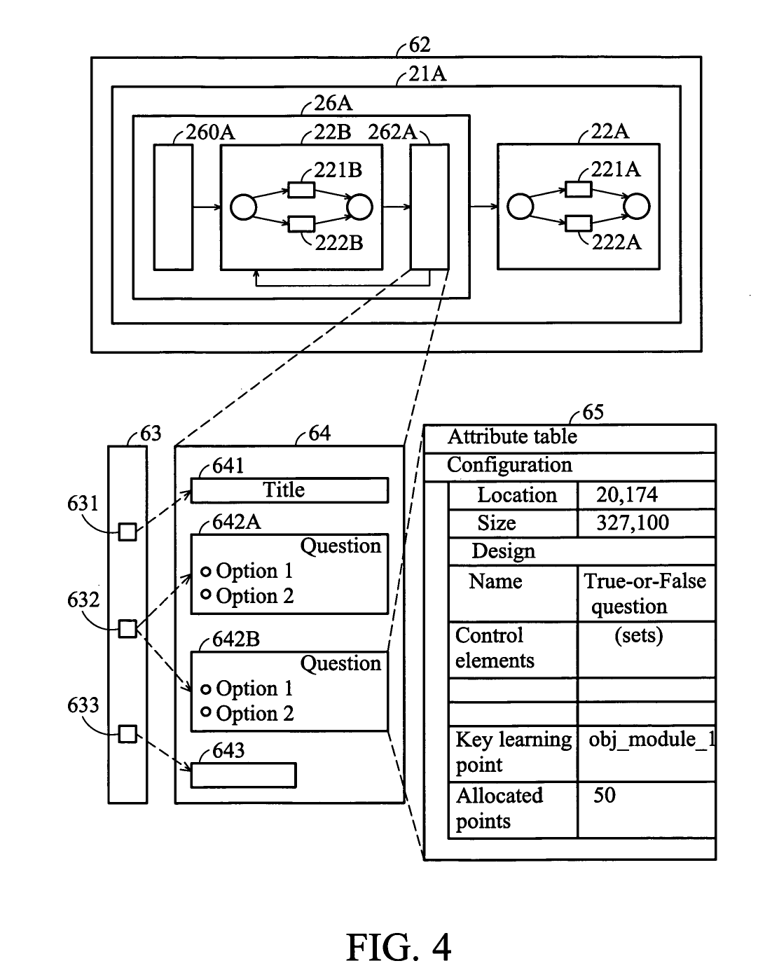

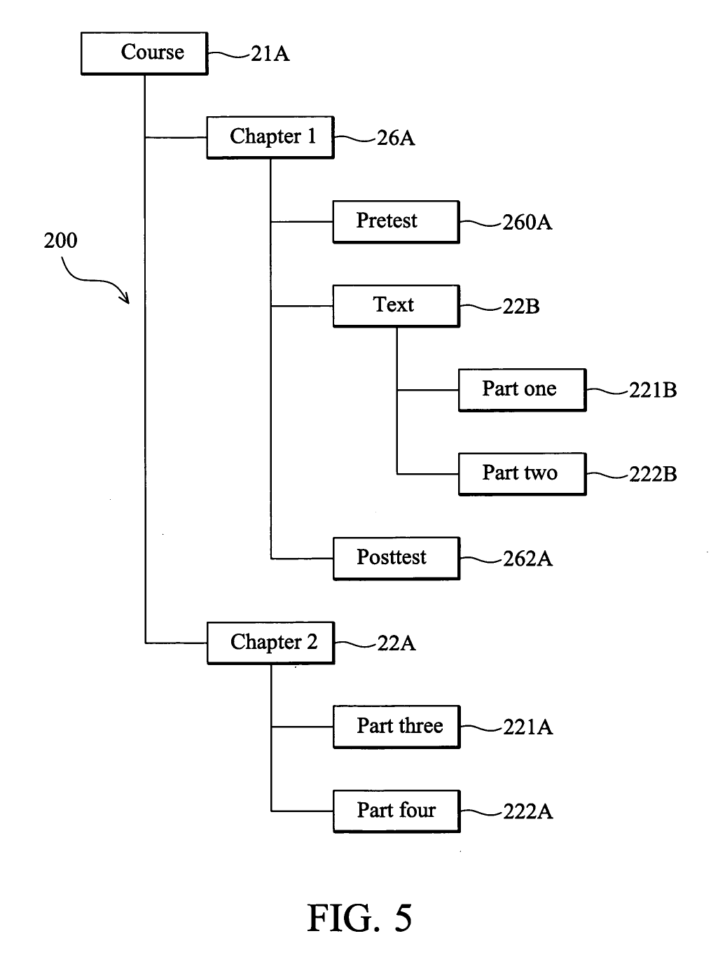

For example, with reference to FIG. 3, when serial learning template 21 is dragged to area 62, a corresponding template object 21A is generated. Similarly, template objects 22A and 22B are generated by dragging selective learning template 22 to area 62. Template object 26A is generated by dragging smart sequencing template 26 to area 62. Next, template object 22A is dragged into learning node 212A; template object 22B into learning node 261A; template object 26A into learning node 211A. The structure diagram of template object 21A shown in FIG. 4 is generated via the dragging operations and may be further modified. For example, the titles of template objects 21A, 26A, 22B, and 22A (delimited by <title> tags) may be “Course”, “Chapter 1”, “Text”, and “Chapter 2” respectively. The titles of learning node 260 and 261A may be “Pretest” and “Posttest” respectively. The titles of learning node 221B and 222B may be “Part one” and “Part two” respectively. The titles of learning node 221A and 222A may be “Part three” and “Part four” respectively. Authoring tool 2 may transform the course structure diagram to course structure diagram 200 in FIG. 5.

With reference to FIGS. 1 and 4, for each learning node within the course structure diagram, course generator 4 generates a course and course content corresponding thereto (step S6) and associates the course to a corresponding learning node thereof on the course structure diagram. For example, course generator 4 provides interface 64 for editing learning node 262A as a posttest. Course generator 4 provides control elements in area 63. Title 641 and button 643 are generated by dragging control elements 631 and 633. Questions 642A and 642B are generated by dragging control element 632. Course generator 4 may generate courses utilizing the techniques disclosed by an U.S. PAT application entitled “SYSTEMS AND METHODS FOR ESTABLISHING EDUCATION WEB PAGE TEMPLATES”.

Course generator 4 provides table 65 for configuring attributes of question 642B, comprising allocated points and a corresponding key learning point thereof (step S8). A key learning point (such as obj_module_1 in FIG. 4) corresponds to a learning concept. For example, key point obj_module_1 may correspond to a learning concept included in another course within the course structure. Each course and each test question may correspond to one or more key points. Different test question or different courses may correspond to the same key point.

Sequencing rules associated with the key point are edited utilizing interfaces provided by authoring tool 2 (step S10). Course structure generator 3 and course generator 4 respectively generate course structure and course content (step S12).

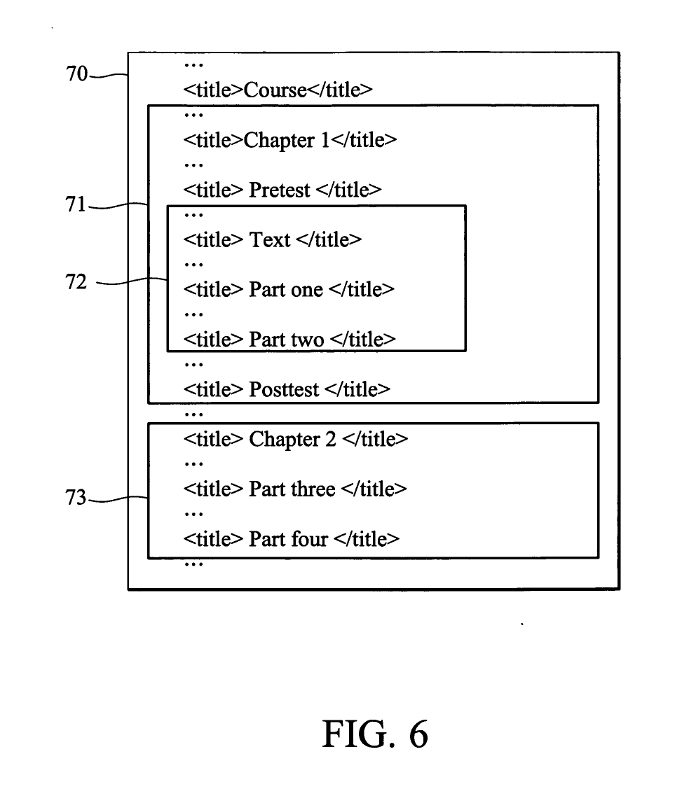

Course structure generator 3 associates the course structure diagram with corresponding sequencing settings and outputs course structure in the form of an XML file. The course structure comprises structure codes and sequencing settings of learning nodes. The structure codes describe the organization of learning nodes. Sequencing settings corresponding to each learning node and each template in the course structure diagram may be referred to the described examples. Note that course structure generator 3 adjusts sequencing settings according to modification on the course structure diagram. Simplified structure codes of course structure diagram 200 are shown in FIG. 6. Blocks 70˜73 respectively correspond to template objects 21A, 26A, 22B, and 22A. Sequencing settings of each template object are included in the corresponding block thereof. The corresponding sequencing settings are previously described and thus areomitted in the schematic diagram. Course structure generator 3 automatically generates a course structure corresponding to the course structure diagram, which comprises sequencing settings of each node in the course structure diagram.

Course generator 4 generates course content of learning node 262A, comprising HTML code and program code, such as javascript code, according to interface 64 and table 65.

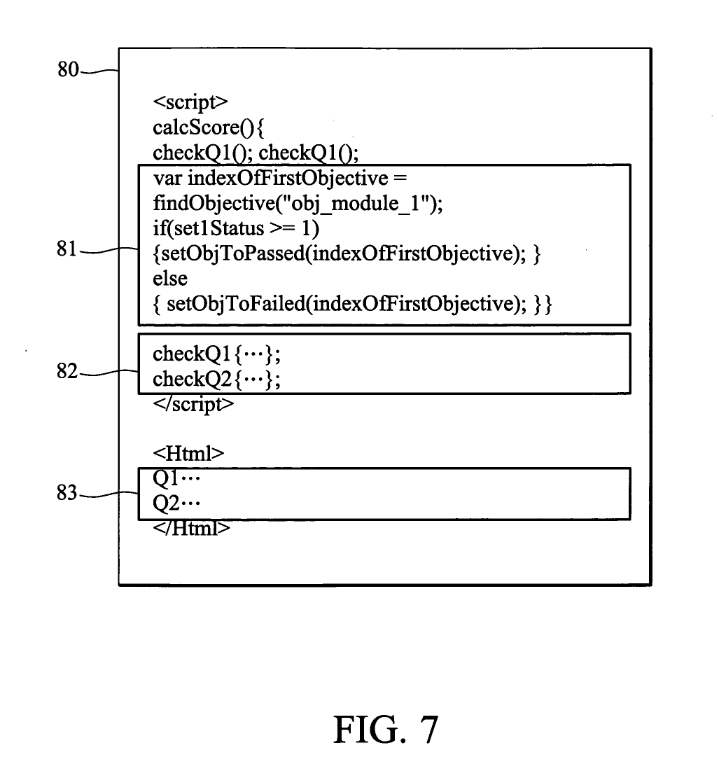

With reference to FIG. 7, course generator 4 generates course content 80 of learning node 262A according to settings on interface 64 and table 65. Block 82 comprises functions to calculate scores. Block 83 comprises program code of test questions. Block 81 comprises a learning status function configuring learning status based on answers to test questions. For example, the learning status function configures data model indexOfFirstObjective based on key learning point obj_module_1 corresponding thereto. Parameter set1Status of key point obj_module_1 reflects the answer to question 642B. Sequencing settings of the course structure may direct the learning order of the learning nodes based on the data model.

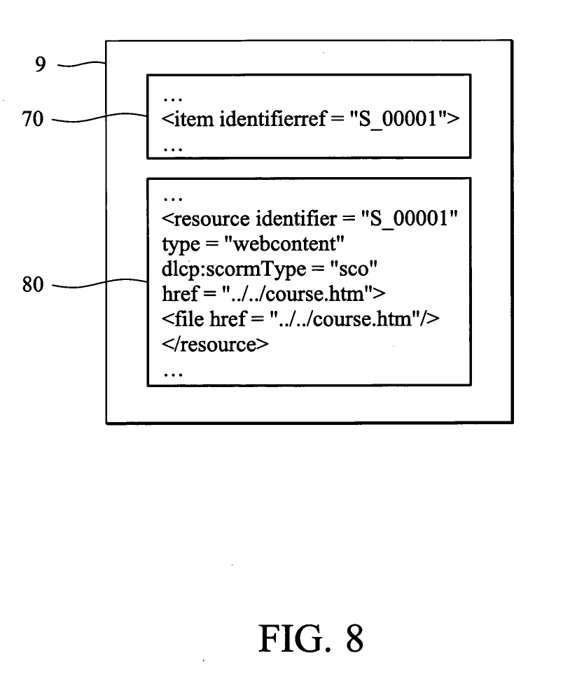

At last, packager 5 packs the course structure and the course content generated by course structure generator 3 and course generator 4 into a course unit (step S14). FIG. 8 shows an XML file of a course unit 9, comprising course structure and course content 80 of block 70. A learning node of the course structure is associated with resources (denoted by <resource>) of course content 80 through identification “S_{—}00001”.

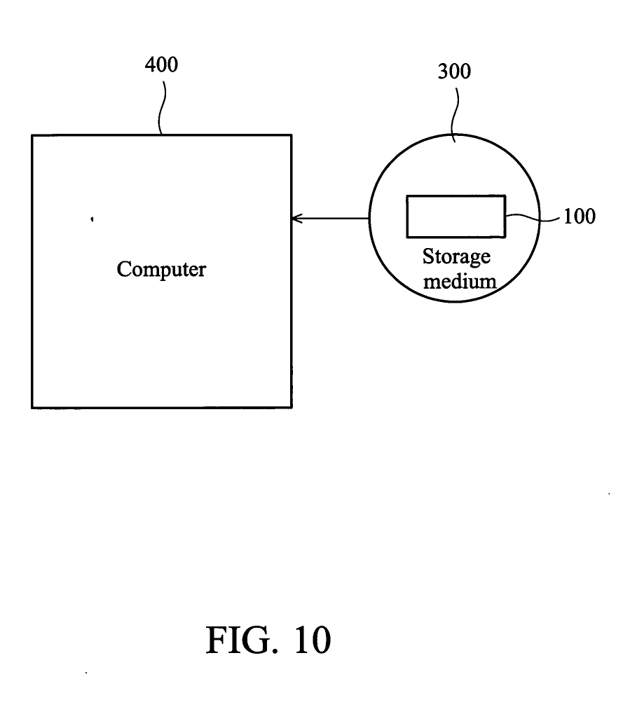

As shown in FIG. 10, adaptive teaching material generation system 100 can be implemented by a computer program stored in storage medium 300. When storage medium 300 is loaded to computer 400, computer 400 executes the adaptive teaching material generation method. Storage medium 300 may comprise a disc drive, a hard disk, a flash memory, or another storage device.

Thus, adaptive teaching material generation system 100 provides sequencing templates for forming a course structure diagram by dragging operations, generates a course structure accordingly, and provides an interface for setting key points of learning in the aspect of course authoring. Adaptive teaching material generation system 100 finally generates course content and packages the course structure and the course content.

While the invention has been described by way of example and in terms of the preferred embodiments, it is to be understood that the invention is not limited to the disclosed embodiments. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. An adaptive teaching material generation system, comprising:
a database providing a plurality of graphical templates for e-learning sequencing;
an authoring tool providing an interface allowing one of the graphical templates to be dragged for forming a structure diagram for sequencing e-learning nodes; and
a course structure generator automatically generating a course structure corresponding to the structure diagram, which comprises sequencing settings of each node.

2. The system as claimed in claim 1, further comprising a course generator generating courses and course content of the nodes and respectively associating the courses to corresponding nodes thereof.

3. The system as claimed in claim 2, wherein a first course associated with the structure diagram comprises a test question, the course generator provides an interface for associating the test question with a corresponding key learning point corresponding to a concept included in another course associated with the structure diagram.

4. The system as claimed in claim 3, wherein the course generator automatically provides the first course with program codes directing configuration of a data model corresponding to the key learning point based on the answer to the test question.

5. The system as claimed in claim 4, wherein a sequencing setting of the course structure is utilized to determine the learning order of the nodes based on the data model.

6. The system as claimed in claim 1, wherein the templates comprises a template of serial learning.

7. The system as claimed in claim 1, wherein the templates comprises a template of selective learning.

8. The system as claimed in claim 1, wherein the templates comprises a template of looped learning.

9. The system as claimed in claim 1, wherein the templates comprises a template of random learning.

10. The system as claimed in claim 1, wherein the templates comprises a template of smart sequencing.

11. An adaptive teaching material generation method, comprising
providing a plurality of graphical templates for e-learning sequencing;
providing an interface allowing one of the graphical templates to be dragged for forming a structure diagram for sequencing e-learning nodes; and
automatically generating a course structure corresponding to the structure diagram, which comprises sequencing settings of each node.

12. The method as claimed in claim 11, wherein a first course associated with the structure diagram comprises a test question, further comprising providing an interface for associating the test question with a corresponding key learning point corresponding to a concept included in another course associated with the structure diagram.

13. The method as claimed in claim 12, further comprising automatically providing the first course with program codes directing configuration of a data model corresponding to the key learning point based on the answer to the test question.

14. The method as claimed in claim 13, wherein a sequencing setting of the course structure is utilized to determine the learning order of the nodes based on the data model.

15. The method as claimed in claim 11, further comprising:
generating courses and course content of the nodes; and
respectively associating the courses to corresponding nodes thereof.

16. The method as claimed in claim 11, wherein the templates comprises a template of serial learning, selective learning, looped learning, random learning, or smart sequencing.

17. A machine-readable storage medium storing a computer program which, when executed, directs a computer to perform an adaptive teaching material generation method as claimed in claim 11.
